(19) United States
(12) Patent Application Publication
(10) Pub. No.: US 2012/0090021 A1
(43) Pub. Date: Apr. 12, 2012

(54) Platform Specific Application Building

(75) Inventors: Walter Luh, Sunnyvale, CA (US); Sean M. Head, Campbell, CA (US)

(73) Assignee: Ansca, Inc., Palo Alto, CA (US)

(21) Appl. No.: 13/272,129

(22) Filed: Oct. 12, 2011

Related U.S. Application Data
(60) Provisional application No. 61/392,417, filed on Oct. 12, 2010.
(60) Provisional application No. 61/392,428, filed on Oct. 12, 2010.

(51) Int. Cl. H04L 9/32; H04L 9/00; G06F 9/45

(52) U.S. Cl. 726/17; 717/138

(57) ABSTRACT

Disclosed are new approaches for building an application for a specific platform. Source code files may be compiled to an intermediate module and transmitted to a build server along with metadata describing a target operating environment. The build server selects an application template including an application shell suitable for the target operating environment. The application shell may be bound to the intermediate module by modifying the application shell to verify a signature of the intermediate module prior to executing it. The application shell may include a binary executable for executing the intermediate module in the target environment. Also disclosed is an approach for providing access to an application on a subscription or trial basis.

### RELATED APPLICATIONS

This application claims priority to U.S. Provisional Application Ser. No. 61/392,428 filed Oct. 12, 2010 and entitled Application Program Authorization Systems and Methods, which is hereby incorporated herein by reference in its entirety.

This application also claims priority to U.S. Provisional Application Ser. No. 61/392,417 filed Oct. 12, 2010 and entitled Template-Based Systems and Methods of Creating Applications, which is hereby incorporated herein by reference in its entirety.

### BACKGROUND

The invention is related to methods and apparatus for building an application from a developer's source code for execution on an arbitrary operating system and target device.

The explosive growth of smart phones and tablet computers added to the ubiquitous laptop and netbook computers has provided a large market for applications. However, the large number of operating systems and device architectures creates difficulties for developers who must develop expertise on a variety of platforms and develop multiple versions of the same application. In addition, a developer must maintain a current software development kit (SDK) for each platform and revise code in response to changes in the SDK for each platform.

In addition to the diversity of platforms, there are multiple providers of application distribution interfaces, e.g. “app stores,” enabling users to download and purchase applications. Application developers must therefore develop expertise and tailor applications for distribution in multiple distribution interfaces in order to maximize the market for their applications. Developers must additionally manage access to their applications to prevent piracy and derive revenue from use of the application.

Time and resources used developing an application for multiple platforms and distribution interfaces and preventing unauthorized access does not add to the value of the application functionality experienced by a user. It therefore would be advancement in the art to provide a system enabling a developer's application to be readily operated on multiple platforms and enabling access to the application to be easily controlled.

### DESCRIPTION OF THE DRAWINGS

The specific features, aspects and advantages of the present invention will become better understood with regard to the following description and accompanying drawings where:

FIG. 1. is a schematic block diagram of a computing device suitable for use in accordance with an embodiment of the present invention;

FIG. 2. is a schematic block diagram of a networking environment suitable for use in accordance with an embodiment of the present invention;

FIG. 3. is a schematic block diagram of software components for implementing an application building system in accordance with an embodiment of the present invention.

FIG. 4. is a process flow diagram of a method for building an application in accordance with an embodiment of the present invention.

FIG. 5. is a schematic block diagram of an application built in accordance with an embodiment of the present invention.

FIG. 6. is a process flow diagram of a method for executing an application built in accordance with an embodiment of the present invention.

FIG. 7. is a schematic block diagram of a build server module in accordance with an embodiment of the present invention.

FIG. 8. is a schematic block diagram of a client module in accordance with an embodiment of the present invention.

FIG. 9. is a process flow diagram of a method for accessing an application in accordance with an embodiment of the present invention.

FIG. 10. is a process flow diagram of a method for accessing a trial subscription to an application in accordance with an embodiment of the present invention.

FIGS. 11A and 11B illustrate a process flow diagram for managing access to an application in accordance with an embodiment of the present invention.

### DETAILED DESCRIPTION OF THE PREFERRED EMBODIMENT

In the following description of the preferred embodiment of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

In the following description, numerous specific details are set forth in order to provide a thorough understanding of the present invention. However, it will be apparent to one skilled in the art that the present invention can be practiced without these specific details. In other instances, well known circuits, components, algorithms, and processes have not been shown in detail or have been illustrated in schematic or block diagram form in order not to obscure the present invention in unnecessary detail. Additionally, for the most part, details concerning networks, interfaces, computing systems, and the like have been omitted inasmuch as such details are not considered necessary to obtain a complete understanding of the present invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . .”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

This application discloses an approach to building an application for a specific platform. In an embodiment, a user precompiles source code into an intermediate module. The intermediate module is transmitted to a build server along with metadata describing a target operating environment. The build server examines the metadata and selects an application template suitable for the target operating environment. The template includes an application shell suitable for launching an application in the target operating environment. The application shell is bound to the intermediate module, such as by means of a project signature of the intermediate module. The application shell may include a binary executable module for executing the intermediate module in the target operating environment. Other aspects of this approach and alternative embodiments are also disclosed herein.

This application also discloses an approach to providing an application on a trial or subscription basis. In an embodiment, a client tool on a client device transmits a request to access an application to an authorization server. The authorization server examines the request and verifies whether the user should be granted access. If so, an authorization ticket is returned to the client tool, which permits the application to execute on the client device. Other aspects of this approach and alternative implementations are also disclosed herein.

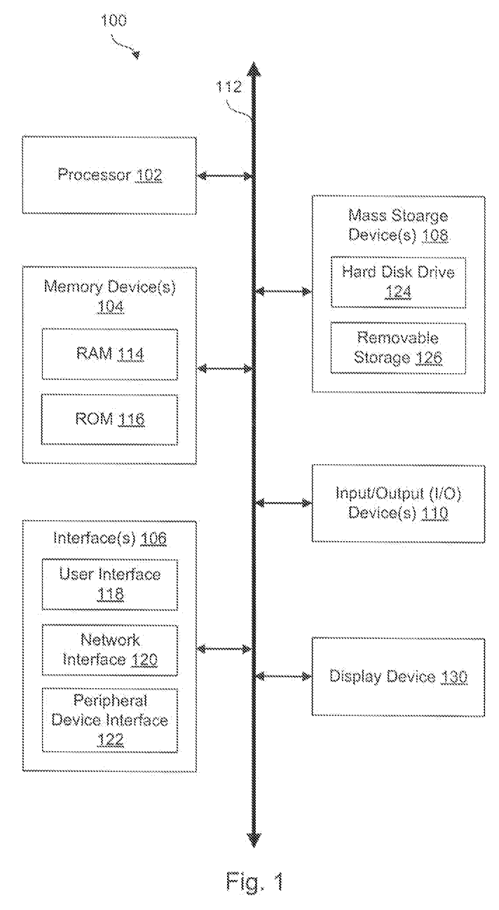

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

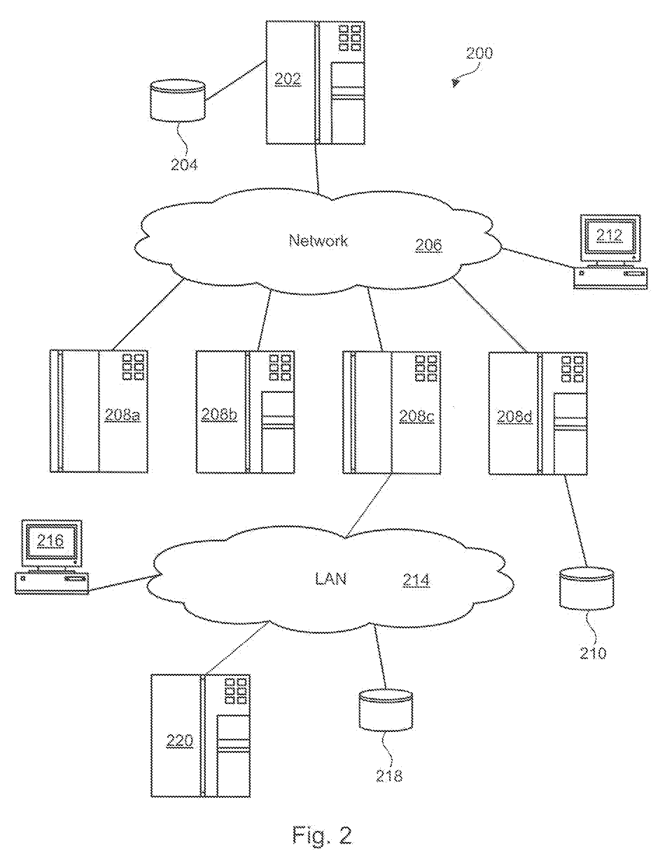

FIG. 2 is a block diagram illustrating an example operating environment 200, including a build server 202 operably coupled to a build database 204. The build server 202 and other components of the environment 200 may be embodied as the computing device 100 and include some or all of the components illustrated in FIG. 1. The database 204 may be a memory device, such as a hard drive, operably coupled to the build server 202 or may be another computing device 100 communicatively coupled to the build server 202. The build server 202 may be coupled to a network 206 such as a LAN, WAN, or the Internet. One or more additional servers 208a-208d may also be operably coupled to the network 206. The servers 208a-208d may host build systems or may provide application subscription services as described hereinbelow. The servers 208a-208d may also provide other services including custom services programmed by an end user. In some embodiments, the build server 202 may also provide an application subscription service as described hereinbelow. One or more of the servers 208a-208d may be operably coupled to a database 210 to facilitate provision of an application subscription service.

One or more workstations 212 may be operably coupled to the build server 202 or one or more of the servers 208a-208d, such as by means of the network 206. The workstation 212 may be used by a user wishing to access the services provided by the servers 208a-208d or build server 202. The workstation 212 may host a browser for presenting a web-based interface to processes running on the servers 208a-208d or build server 202. The workstation 212 may be embodied as a computing device such as that illustrated in FIG. 1. The workstation 212 may be a desktop, laptop, or tablet computer. The workstation 212 may also be embodied as a smart phone or other portable computing device.

One or more of the servers 208a-208d may be coupled to a local area network (LAN) 214 having one or more of additional workstations 216, databases 218, and servers 220. In such embodiments, the server 208c coupled to the LAN may provide a gateway to a system seeking to access resources provided on the workstation 216, database 218, or server 220. Accordingly, the services “provided” by the server 208c may include those provided components coupled to the LAN 214 and accessed by means of the server 208c.

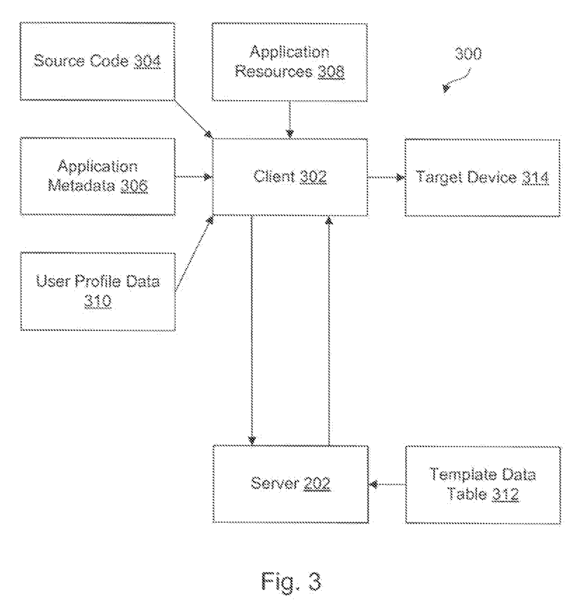

FIG. 3 illustrates a build system 300 suitable for performing an application building method in accordance with an embodiment of the present invention. A client device 302, such as a workstation 212 or server 208a-208d, may be in data communication with one or more devices storing source code 304, metadata 306, and any other application resources 308, such as non-executable application resources. The metadata 306 describes a target operating environment for an application, e.g., an operating system, operating system version, and/or target device. The client device 302 may also access user profile data for authenticating the client device with the server 202 and for providing to the server 202 for generating a user signature.

The client device 302 compiles the source code 304 into an intermediate format and transmits the resulting intermediate module to the server 202 along with the metadata and user profile information. The server 202 is in data communication with a template data table 312 storing, or pointing to, application templates for various operating environments. The template data table 312 may include records indicating one or more of a client version, a client product type, a target platform operating system and version, target device, and a file location for the template corresponding to the record. The template data table 312 may include additional metadata supplied by the server to facilitate building of a platform-specific application. The server 202 may also generate metadata for a specific application. For example, the server 202 may define a globally unique application identifier for a particular app based on metadata 306 provided by the client device 302. Metadata supplied by the server 202 may also include a signature for signing the application to facilitate identifying the source of the application to an end user. The server 202 selects an application template from the template data table 312 according to the metadata and uses the application template to build an application for the target operating environment. The server 202 then transmits the built application to the client device 302, which may then distribute the built application to a target device 314.

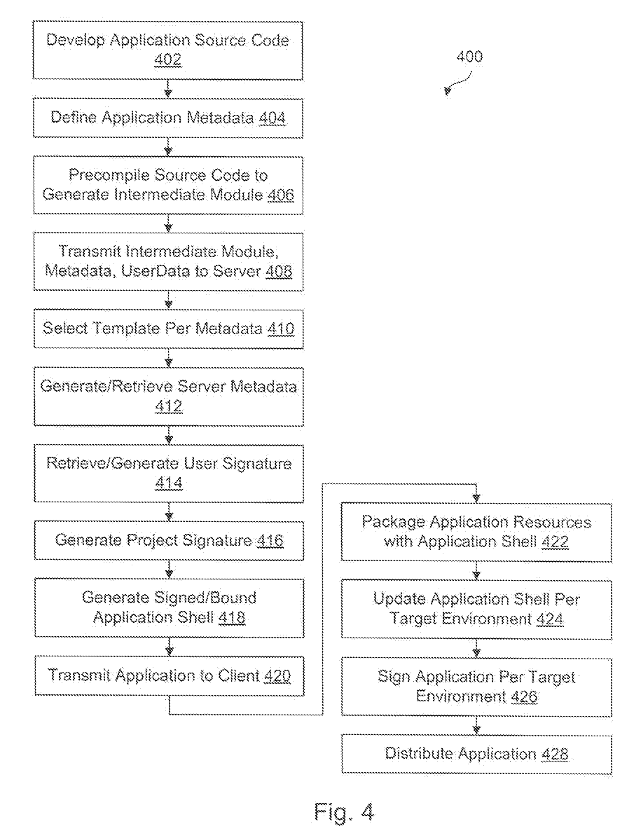

FIG. 4 illustrates a method 400 for building an application for a specific platform, i.e., a specific operating system and/or device. A user may first develop 402 source code defining the desired functionality of the application. The source code 402 may be written in a scripting language or a compiled language. Metadata may then be defined 404 for the application. The metadata may describe such things as a target operating system, target operating system version, and target device. The metadata may also identify the developer (hereinafter “client”), the client version identifier, client product type.

The metadata may also indicate how a final application is to be distributed to users. For example, the metadata may indicate that the final application is to be distributed as a trial version, purchased version, or as a paid subscription version. In some embodiments, the server 202 providing application building services may also provide application downloading and sale services. Alternatively, the server 202 may be in data communication with another server providing such services or have access to data describing the applications offered for downloading for a purchase price or as a subscription service. In such embodiments, the metadata may not indicate how the software is to be distributed. Instead, the build server 202 may retrieve this information from existing records associated with the client requesting building of an application and used to manage the provision of application for purchase or use on a subscription basis.

The source code developed at step 402 may be precompiled 406 to an intermediate form. This may include processes conventionally performed by a preprocessor such as including function libraries and executing any preprocessor directives. Precompiling 406 may also include performing some or all of the processes performed by a compiler up to and including generating a binary executable that is executable directly by a processor. For example, precompiling 406 may include performing variable type-checking, syntax checking, linking function calls to corresponding function definitions, replacing macros with corresponding code segments, and other compiler functions. Where the source code is written in a scripting language, the output of precompiling 406 is typically not a binary executable code, but rather an intermediate script that has combined various source code files into an intermediate software module that can be executed by an interpreter for that scripting language.

The output of the precompiling step 406 is an intermediate module that is transmitted 408, along with the metadata defined at step 404, to the build server 202. This may include transmitting the intermediate module from the workstation 212 or another server 208a-208d to the build server 202. The build server 202 examines the metadata and selects 410 an application template corresponding to platform information contained therein, such as an operating system, operating system version, device type, and the like. The application template selected 410 may also correspond to metadata indicating how the application is to be distributed, i.e., as a trial subscription, paid subscription, or purchased application. The application template may define one or more of source code files, precompiled binaries, function libraries, dynamic link libraries (DLL), and other resources for enabling the intermediate module to execute on a platform identified by the metadata. The template may also define the manner in which the intermediate module is to be incorporated with these resources. In some embodiments, the template includes an execution module, which may be in a precompiled binary format, for executing the intermediate module on a target platform. The template may also define an empty application shell suitable for the target platform. The build server 202 may additionally generate and/or retrieve 412 metadata specific to the application being built. The metadata may include, for example, a globally unique application identifier.

In order to guarantee the authenticity of software and to assure a user that it is not a virus or other malicious code, an application may be signed to indicate the source. Accordingly, the method 400 may include generating 414 a user signature for signing the application using user profile data provided in the metadata. Where the client submitting the intermediate module already has a user signature available to the build server 202, step 414 may simply include retrieving the signature based on user profile data provided in the metadata.

A project signature based on the intermediate module may also be generated 416. The project signature uniquely identifies the content of the intermediate module, such that only the intermediate module will have the project signature. The project signature may be generated 416 by generating a digest of the intermediate module, such as a hash. An MD5 hash has been found to be suitable, but other types of digests may also be used.

An application may then be generated 418. Generating 418 the application may include modifying or renaming files from the selected template in accordance with the metadata received from the user. Generating 418 the application may include binding the intermediate module to the application shell defined by the template selected at step 410. Binding may include modifying the application shell such that only an intermediate module having the same project signature will be executed by the application shell. Alternatively or additionally, the execution module responsible for interpreting the intermediate module may be modified to execute only an intermediate module having the project signature.

This may be accomplished by encrypting the project signature using a private key, which is not disclosed to a user. The executable code, e.g. the application shell and/or execution module, are then modified to store the encrypted project signature and the public key used to decrypt the project signature. When the application is launched by an end user, the executable code then verifies that the signature of the intermediate module is valid. This may include generating a new signature for the intermediate module and comparing the new signature to the encrypted project signature. If the new signature does not match the encrypted project signature, then the application will refuse to execute and may automatically quit.

Some or all of the steps of generating or retrieving 414 a user signature, generating 416 a project signature, and generating 418 a signed/bound application may be omitted. These steps provide additional security, but the advantages of the invention do not require them to be performed. Accordingly, generating 418 a signed/bound application may simply include generating 418 an application without signing it with a user signature or binding it to an intermediate module using the project signature.

The built application may then be transmitted 420 to the user. The built application may include the application shell, execution module, and any other resources defined by the template. This may include transmitting these files to the workstation 212, or server 208a-208d, that requested building of an application. Upon receiving the built application, the client may perform additional processing. For example, an application may have other non-executable resources associated therewith that may be packaged 422 with the built application. Non-executable resources may include databases, audio files, video files, image files, digital models, and the like. The client may also perform 424 additional updates on the application shell or other resources to prepare them for execution on a host platform. The client may then sign 426 the built application in a manner appropriate for the target operating environment and distribute 428 the application to end users. Where security is not an issue, the signing step 426 may be omitted.

The method 400 as described hereinabove includes interaction between a user device and the build server 202 remote from the user device. However, the method 400 may also be advantageously performed on a single device, such that transmission of data between a user device and the server 202 may be replaced with communication of data between local software modules on a single device or devices owned or controlled by the same entity.

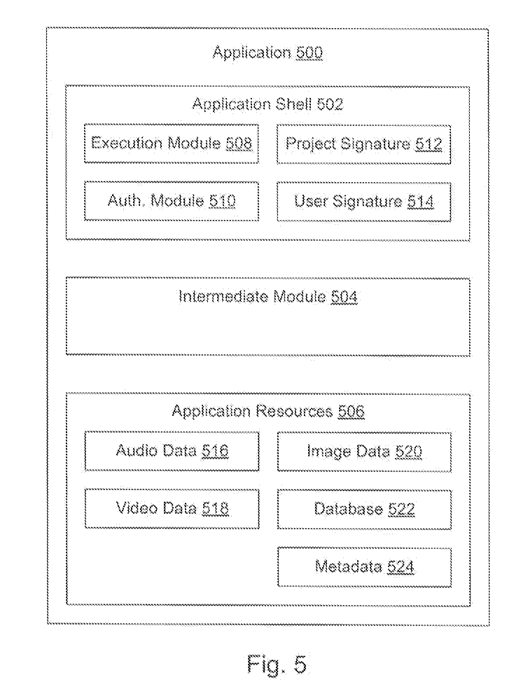

FIG. 5 illustrates a built application 500. As noted above, the application 500 includes an application shell 502, intermediate module 504, and any other application resources 506. The application shell 502 includes components necessary to launch an application in a target environment. The application shell 502 may perform such functions as performing dynamic linking with libraries found in the target operating environment, initializing operating system and device resources, managing input and output with operating system interfaces and/or device interfaces, and the like. The application shell 502 may also initiate execution of the intermediate module 504. In some embodiments, the application shell 502 includes an execution module 508. The execution module 508 may be a precompiled binary application suitable for the target environment and programmed to execute the intermediate module. The execution module 508 may be embodied as an interpreting application for the scripting language in which the intermediate module 504 is written.

The intermediate module 504 contains the code defining the desired functionality of the application 500, as opposed to functions that are generic to all applications executing in a target operating environment. The intermediate module 504 may be written in a scripting language, such as Lua, Pearl, PHP, JavaScript, and the like.

The intermediate module 504 may define a project signature obtained by performing an algorithm on the content of the intermediate module 504, such as a digest or hash algorithm, or the like. The application shell 502 may include an authentication module 510 programmed to obtain the signature of the intermediate module 504 and compare it to a project signature 512 stored, possibly in encrypted form, in the application shell 502. If the signatures do not match, the application shell 502 refuses to execute the intermediate module 510. The application shell may also include a user signature 514 used to verify the author of the application 500 as known in the art.

The intermediate module 504 may use non-executable data to perform its function. Accordingly, the application resources 506 may be packaged with the application 500. The application resources 506 may include audio data 516, video data 518, image data 520, and one or more databases 522 of other data. The application resources 506 may include metadata 524 including some or all of one or both of the metadata supplied by the developer and metadata supplied by the server as described hereinabove. For example, for video game, the databases 522 may define computer models for rendering characters on the screen and defining other aspects of the game.

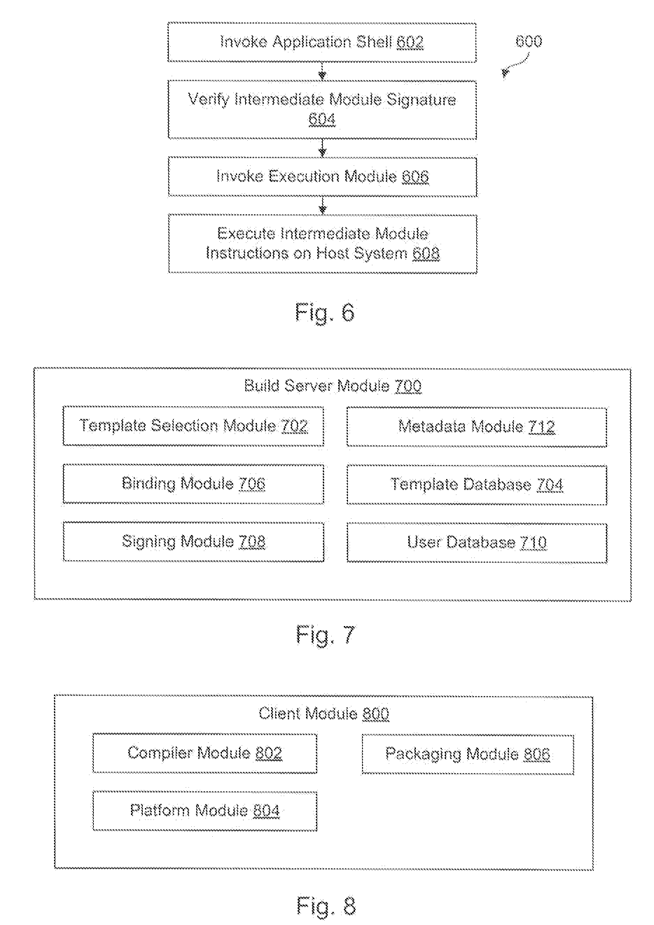

FIG. 6 illustrates a method 600 for executing an application built as described hereinabove on an end user device, which may have some or all of the components of the computing device 100. The application shell 502 may be launched 602 in the same manner as applications native to the end user device and operating system. The application shell 502 then verifies 604 the signature of the intermediate module 504 relative to a project signature 512 stored in the application shell 502. This may include decrypting the project signature 512 stored in the application shell 502 and comparing it to a signature of the intermediate module 504. Alternatively, the signature of the intermediate module 504 may be encrypted and compared to the encrypted project signature 512. If the intermediate module is verified to match the project signature, then the execution module 508 may be invoked 606 to execute the intermediate module 504. In some embodiments, the security provided by verifying the signature of the intermediate module is not necessary. Accordingly, in such embodiments, verifying 604 the signature of the intermediate module may be omitted and the execution module 508 is invoked 606 regardless of the signature of the intermediate module. The execution module 508 then executes 608 instructions stored in the intermediate module 504. For example, where the intermediate module 504 is written in a scripting language, the execution module 508 may interpret the script to generate machine level instructions for executing the intermediate module 504.

FIG. 7 illustrates a build server module 700 suitable for building an application on a server 202 in accordance with the methods described hereinabove. The build server module 700 may be stored on a computer readable medium such as a hard drive, CD-ROM, flash memory, volatile memory, or the like. For example, the build server module 700 may be stored in the RAM 114, ROM 116, hard disk drive 214, or removable storage device 126 of a server 202 embodied as a computing device 100. The build server module 700 may include computer program code to execute some or all of the methods and functionality described hereinabove.

For example, the build server module 700 may include a template selection module 702 operable to examine metadata provided by a user and select an application template, such as from a template database 704, suitable for an operating environment identified in the metadata. The build server module 700 may also include a binding module 706 for binding an intermediate module to the application shell of the selected application template as described hereinabove. The build server module 700 may also include a signing module 708 for signing the bound application shell and intermediate module with an author's signature. The signing module 708 may generate the user signature based on the metadata or retrieve an existing signature from a user database 710 based on a user identified by the metadata. In embodiments where the security of binding and signing are not needed, the binding module 706 and signing module 708 may be omitted. The build server module 700 may also include a metadata module 712 programmed to generate metadata for a particular application. The metadata may be retrieved from one of the databases 704, 710, generated based on metadata supplied by a client, or generated without reference to either of these sources. The metadata generated by the metadata module 712 may include, for example, a globally unique application identifier for a particular application built by the build server 202.

FIG. 8 illustrates a client module 800 for interacting with a server module 700 to build an application for an arbitrary platform. The client module 800 may be stored on a computer readable medium such as a hard drive, CD-ROM, flash memory, volatile memory, or the like. For example, the client module 800 may be stored in the RAM 114, ROM 116, hard disk drive 214, or removable storage device 126 of a workstation 212 or server 208a-208d embodied as a computing device 100.

The client module 800 includes a compiler module 802 for compiling source code into an intermediate software module as described hereinabove. The client module 800 may also include a platform module 804 for making platform specific modifications to an application shell received from the build server 202 as described hereinabove. The client module 800 also includes a packaging module 806 for adding application resources, such as non-executable application data, to the bound application shell and intermediate module as described hereinabove.

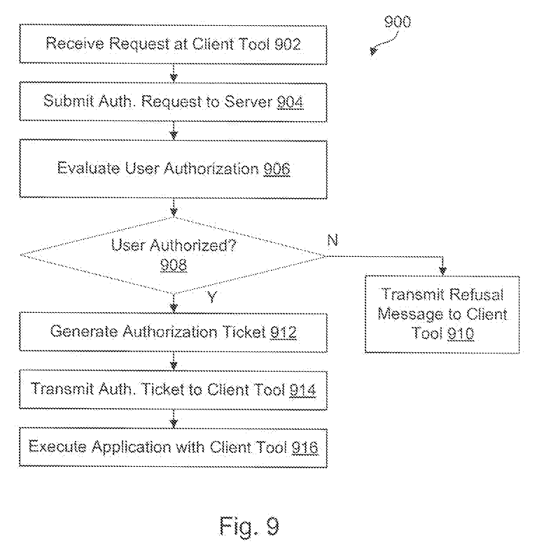

Referring to FIG. 9, the systems and methods described hereinabove may advantageously be used to generate applications for use in a system providing applications for downloading for a purchase price or as a subscription service. In some methods of use, an application may be downloaded from a distribution interface or “app store” and later activated using the methods described herein. The illustrated method 900 may be used to manage access to applications on a trial basis or as a subscription. A client tool executing on an end user device may receive 902 a request to access an application. The client tool may be a module of the application, such as the application shell described hereinabove, or may be a separate software module that is separately invoked by a user. Where the client tool is part of an application, the client tool may interpret attempts to launch the application as receiving 902 a request to access the application.

The client tool may then submit 904 a request for authorization to an authorization server. The request submitted 904 may include one or more of an application identifier, a device identifier of the target device on which the application will execute, an operating system of the target device, a user identifier, and a password. The authorization server may be the same as the build server 202 or may be hosted by another server 208a-208d. The authorization server evaluates 906 the user's authorization based on the information provided in the request. If the user is not found 908 to be authorized to use the application and to use the application on the target device, then a refusal message is transmitted 910 to the target device and the method ends. Upon receiving the refusal message, the client tool may display a refusal message and does not launch the application identified by the request.

If the user is found 908 to be authorized, an authorization ticket is generated 912 and transmitted 914 to the target device. The authorization ticket may include the application identifier and target device identifier. The authorization ticket may also include an operating system identifier and/or user identifier. Upon receiving the authorization ticket, the client tool invokes 916 execution of the application. The client tool may verify that the data stored in the authorization ticket corresponds to the requested application and the device and operating system on which the application is requested to execute. If the authorization ticket data does not correspond to the operating environment, the client tool will not invoke 916 execution of the requested application.

The application may have more than one operational mode. Each mode may have a different set of functions and may have different performance. For example, in a basic mode, less functionality or performance may be available than for a premium mode. In such embodiments, the request to access an application may indicate what operational mode is desired. Likewise, the authorization ticket may indicate what operational mode is permitted. The client tool may invoke operation of the application in the operational mode indicated in the authorization ticket. As indicated hereinabove, the application shell may include an execution module that defines two or more operational modes. The application shell or execution module may therefore operate as the client tool to verify the operational mode permitted by the authorization ticket and causing operation of the execution module in that operational mode.

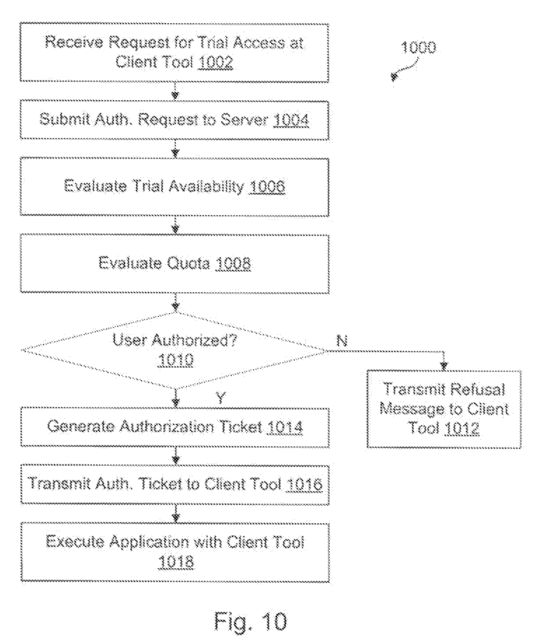

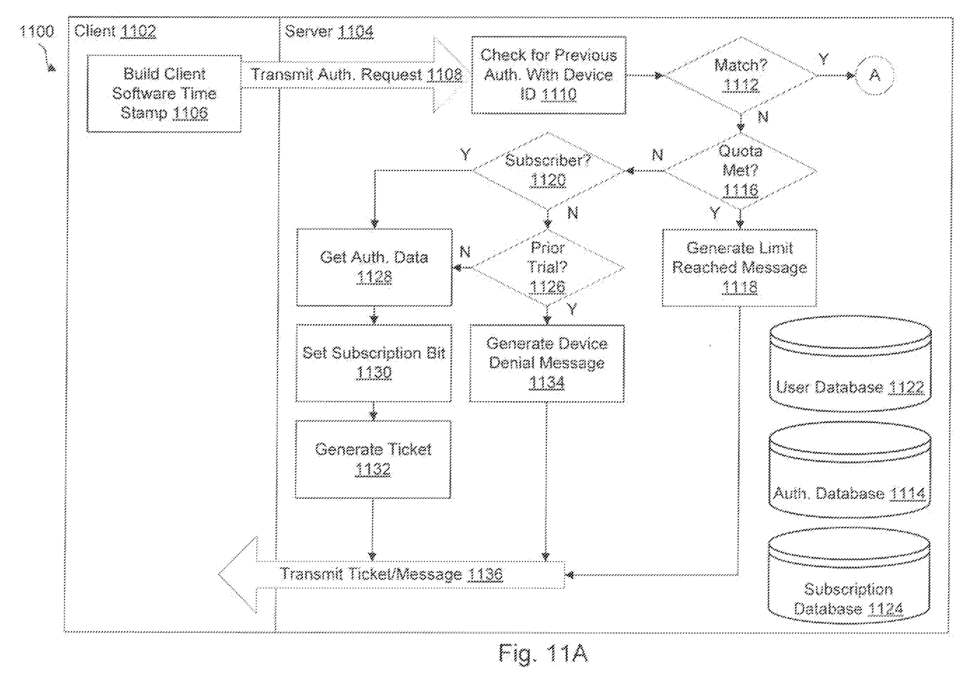

Referring to FIG. 10, the systems and methods described hereinabove may advantageously be used to generate applications for use in a system providing applications for access on a trial basis. The trial subscription may allow a user to try all of the operational modes available for an application, or less than all operational modes. A client tool executing on an end user device may receive 1002 a request for trial access of an application. The client tool may be a module of the application, such as the application shell described hereinabove, or may be a separate software module that is separately invoked by a user. Where the client tool is part of an application, the client tool may interpret attempts to launch the application as receiving 1002 a request to access the application if a subscription or prior trial is not found to exist on the device on which the application is requested to execute.

The client tool may then submit 1004 a request for a trail authorization to an authorization server. The request submitted 1004 may include one or more of an application identifier, a device identifier of the target device on which the application will execute, an operating system of the target device, a user identifier, and a password. The authorization server evaluates 1006 the user's request for trial access based on the information provided in the request. Evaluating 1006 the user's request may include evaluating whether the device identified in the request has other trial access associated therewith. If a trial access has already been granted to the device identified in the request and a time stamp of the request does not fall within the access interval for the prior trial access, then the user is not granted access to the application on the device. If a trial access has been granted but the request still falls within an access time interval, then the request may be granted, provided the target device is within the quota associated with the application and user as described below. If not trial access has been granted to the user or the device associated with the request, trial access may be granted.

The method 1000 may also include evaluating a quota associated with a user or target device. For example, a user may be allowed to access an application on a trial basis on a limited number of devices. If the target device identified in the request has not already been granted trial access and the user identified in the request has already requested trial access on a number of devices equal to the quota, then the user will not be granted access on the device identified in the request.

If the user is not found 1010 to be authorized to use the application on a trial basis, due to prior expired trials or to many authorized devices, a refusal message is transmitted 1012 to the target device and the method 1000 ends. Upon receiving the refusal message, the client tool may display a refusal message and does not launch the application identified by the request.

If the user is found 1010 to be authorized, an authorization ticket is generated 1014 and transmitted 1016 to the target device. The authorization ticket may include the application identifier and target device identifier. The authorization ticket may also include an operating system identifier and/or user identifier. The authorization ticket may also indicate an access interval during which the authorization ticket is available for trial access. Upon receiving the authorization ticket, the client tool invokes 1018 execution of the application. The client tool may verify that the data stored in the authorization ticket corresponds to the requested application and the device and operating system on which the application is requested to execute. If the authorization ticket data does not correspond to the operating environment, the client tool will not invoke 1018 execution of the requested application.

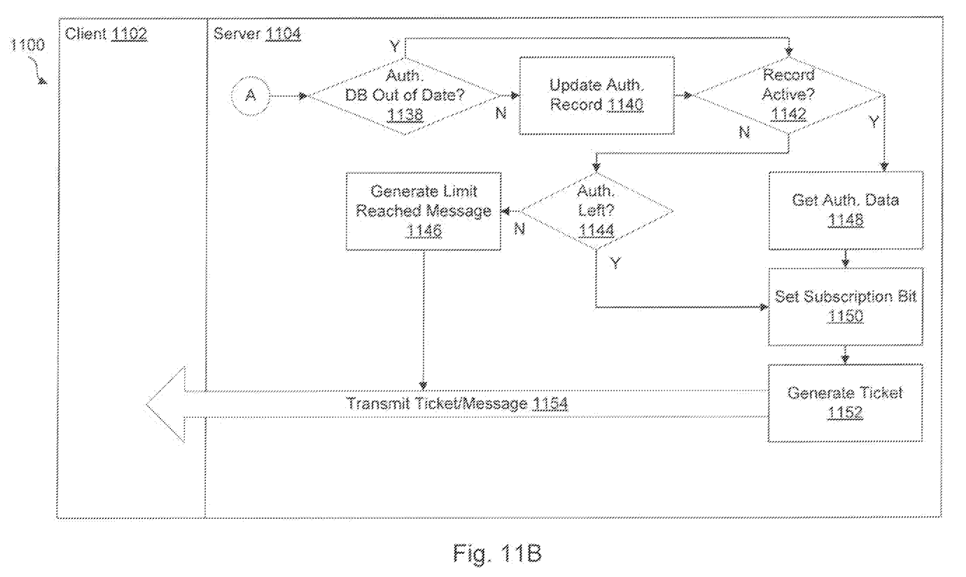

FIGS. 11A and 11B illustrate a method 1100 for managing access to applications on a subscription or trial basis. The method 1100 may be initiated by a user requesting to access an application. The method may include interaction between a client module 1102 executed on an end user device, such as a workstation 212, and a server module 1104 executed on an authorization server, such as a server 208a-208d. Computer program code implementing the portion of the method 1100 performed by one or both of the client module 1102 and server module 1104 may be stored on a computer readable medium such as a hard drive, CD-ROM, flash memory, volatile memory, or the like. For example, the client module 1102 and server module 1104 may be stored in the RAM 114, ROM 116, hard disk drive 214, or removable storage device 126 of a computing device 100.

The method 1100 may include building 1106 of a timestamp by the client module. The time stamp is a representation of the time a request to access an application is generated. A request for authorization to access a requested application is then transmitted 1108 to the server module 1104. The request may include the time stamp, a user identifier, a target device identifier, an operating system or platform identifier, and an application identifier corresponding to the requested application. The request may also indicate an operational mode as discussed hereinabove.

Upon receiving the request, the server module 1104 may evaluate 1112 whether the device identified in the request matches any authorized or previously authorized devices in an authorization database 1114 for the application identified in the request. The authorization database 1114 may include authorization records for each authorized device. Each record may a user identifier, a date of creation, a date of expiration, a device identifier, platform identifier, an active/inactive status indicator, a client version timestamp, a subscription type (e.g., trial or paid subscription). The subscription type may indicate one or more of whether the subscription is or is not a trail subscription and an operational mode for the application. The client version timestamp may be a build date for the application associated with the record.

If the device identifier of the request is found 1112 to match an authorization record, then processing proceeds as illustrated in FIG. 11B. If not, then the server module 1104 evaluates 1116 whether adding the device identified in the request will exceed the device quota for the user identified in the request for the requested application. If so, then a “limit reached” message to inform the client module 1102 why the request was refused.

If not, then, the server module 1104 evaluates 1120 whether the user identified in the request is a subscriber for the requested application. This may include searching for a record corresponding to the identified user in records stored in a user database 1122 and a record of subscriptions for that user in a subscription database 1124. If not, then the server module evaluates 1126 whether one or both of the user and device identified in the request has had a prior trial access to the application identified in the request. This information may be found in one or both of the authorization database 1114 and user database 1122

If the user is found 1120 to be a subscriber or if no expired trial access is found 1126, then authorization data may be retrieved 1128 or generated to enable generation of an authorization ticket. This may include retrieving or generating an access code or other data structure for unlocking the requested application. In some embodiments, the existence of a valid subscription or trial subscription are indicated by setting a bit in the authorization data. Accordingly, this bit may be set 1130 to indicate a subscription. An authorization ticket as described hereinabove may then be generated 1132. If one or both of the user and device identified in the request are found 1126 to have already had a prior trial, then a denial message is generated 1134 indicating that access is not permitted based on a prior trial and lack of a subscription. The authorization database 1114 may be updated to include an authorization record indicating that the device identified in the request has a valid authorization to access the application. This may include setting the active/inactive field of the record to “active.” The record may also include values for other fields of the authorization record as described above, such as one or more of whether the authorization is a trial subscription, when it was started, when it will end, the user identifier associated with the request, a platform identifier, and the device identifier associated with the request.

An authorization ticket or any messages indicating a denial of access may be transmitted 1136 to the client module. Upon receiving an authorization ticket, the client module 1102 may invoke the requested application as described hereinabove. If not authorization ticket is received, then the client module 1102 does not invoke the requested application and may display the messages received from the server module 1104.

Referring to FIG. 11B, if the device identified in the request is found 1112 to match a device recorded in the authorization database, the server module 1104 may evaluate 1138 whether the authorization database 1114 is out of data. If so, then the authorization database is updated 1140. Updating may include setting an authorization record from active to inactive if an access interval for that authorization record is found to have expired, in the case of a trial subscription record. In either case, the authorization record found 1112 to match the device identified by the request may be evaluated 1142 to determine whether it is active. If not, the server module 1104 may evaluate 1144 whether a user identified in the request has any more device authorizations left, i.e., whether the user is permitted to have any more authorized devices accessing a subscription for the requested application. If not, then a message is generated 1146 indicating that the authorization limit has been reached.

If the authorization record is found 1142 to be active or the user is found 1144 to have authorizations left, then authorization data is retrieved 1148 or generated, a subscription bit in the authorization data is set 1150, and an authorization ticket is generated 1154, as described hereinabove. The authorization ticket or any messages denying access are transmitted 1154 to the client module 1102. The client module 1102 then grants or denies access according to the authorization ticket or messages received as discussed hereinabove.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet-related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The software code may also include scripting languages such Pearl, Python, Lua, PHP, and the like. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention, this is used for transitive and non-transitive storage. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state during transitive and non-transitive storage. The invention is not limited to any particular type of memory device, or any commonly used protocol for storing and retrieving information to and from these memory devices, respectively.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Finally, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

What is claimed is:

1. A method for building an application comprising:
compiling application source code to generate an intermediate module;
generating metadata describing a target operating environment;
generating an application shell suitable for the target operating environment using the metadata; and
binding the application shell to the intermediate module.

2. The method of claim 1, wherein the metadata includes a target operating system identifier.

3. The method of claim 2, wherein the metadata includes a target device identifier.

4. The method of claim 1, wherein the application shell includes an execution module configured to execute the intermediate module in the target operating environment.

5. The method of claim 1, wherein the application shell is programmed to verify a user's privileges prior to executing the intermediate module.

6. The method of claim 1, wherein generating the application shell comprises selecting a pre-compiled shell suitable for the target operating environment.

7. The method of claim 1, wherein binding the application shell to the intermediate module comprises generating a signature of the intermediate module and modifying the application shell to execute only a module having the signature.

8. The method of claim 1, further comprising signing the application shell with a user signature.

9. The method of claim 1, further comprising packaging the application shell and intermediate module with one or more application resources.

10. The method of claim 1, wherein the application resources include at least one of audio files, image files, and video files.

11. A method for building an application comprising:
receiving, at a server, an intermediate module including compiled source code from a user computing device;
receiving, at the server, metadata describing a target environment;
generating, on the server, an application shell suitable for the target operating environment using the metadata;
binding, on the server, the application shell to the intermediate module; and
transmitting from the server to the user computing device the application shell.

12. The method of claim 11, wherein the metadata includes a target operating system identifier.

13. The method of claim 12, wherein the metadata includes a target device identifier.

14. The method of claim 11, wherein the application shell includes an execution module configured to execute the intermediate module in the target operating environment.

15. The method of claim 14, wherein the application shell is programmed to verify a user's privileges prior to executing the intermediate module.

16. The method of claim 11, wherein generating the application shell comprises selecting a pre-compiled shell suitable for the target operating environment.

17. The method of claim 11, wherein binding the application shell to the intermediate module comprises:
generating a signature of the intermediate module; and
modifying the application shell to execute only a module having the signature.

18. The method of claim 1, further comprising signing, on the server, the application shell with a user signature.

19. The method of claim 1, further comprising packaging, at the user computing device, the application shell and intermediate module with one or more application resources.

20. The method of claim 1, wherein the application resources include at least one of audio files, image files, and video files.

21. A method for building an application comprising:
compiling, on a user device, source code into an intermediate module;
generating, on the user device, metadata describing a target operating environment;
transmitting the intermediate module and metadata from the user device to a server; and
receiving from the server an application shell suitable for executing in the target operating environment, the application shell being bound to the intermediate module.

22. The method of claim 21, wherein the metadata includes a target operating system identifier.

23. The method of claim 22, wherein the metadata includes a target device identifier.

24. The method of claim 21, wherein the application shell includes an execution module configured to execute the intermediate module in the target operating environment.

25. The method of claim 24, wherein the application shell is programmed to verify a user's privileges prior to executing the intermediate module.

26. The method of claim 21, wherein the application shell is bound to the intermediate module by means of a signature of the intermediate module, such that the application shell is programmed to execute only a module having the signature of the intermediate module.

27. The method of claim 1, further comprising packaging, on the user computing device, the application shell and intermediate module with one or more application resources.

28. The method of claim 1, wherein the application resources include at least one of audio files, image files, and video files.

29. A method for executing an application comprising:
initiating execution of an application shell on a user device;
checking, using the application shell, a signature of an intermediate module; and
if the signature matches a signature associated with the application shell, executing the intermediate module by means of the application shell.

30. The method of claim 29, wherein the application shell has an author signature associated therewith, the method further comprising verifying the author signature.
